(19) United States
(12) Patent Application Publication
(10) Pub. No.: US 2013/0124994 A1
(43) Pub. Date: May 16, 2013

(54) METHOD FOR CONTENT PRESENTATION DURING TRICK MODE OPERATIONS

(71) Applicants: Jian Feng Chen, Beijing (CN); Xiao Jun Ma, Beijing (CN)

(72) Inventors: Jian Feng Chen, Beijing (CN); Xiao Jun Ma, Beijing (CN)

(73) Assignee: THOMSON LICENSING, Issy de Moulineaux (FR)

(21) Appl. No.: 13/810,086

(22) PCT Filed: Jul. 20, 2010
(86) PCT No.: PCT/CN2010/001088

§ 371 Date: Jan. 14, 2013

(51) Int. Cl. G06F 17/30

(52) U.S. Cl. CPC G06F 17/30017
USPC 715/716

(57) ABSTRACT

It is provided a method for content presentation during trick mode operations, wherein a first content file is associated with a plurality of content items and each content item corresponds to a content segment of the first content file, the method comprises the steps of receiving an instruction for a chosen trick mode operation when a content segment of the first content file is played; and performing the chosen trick mode operation on the content segment of the first content file and meanwhile playing at least one content item among the plurality of content items, wherein, the at least one content item corresponds to the content segment of the first content file and the chosen trick mode operation.

### TECHNICAL FIELD

The present invention relates to user interface, and more particularly, relating to a method for content presentation during trick mode operations.

### BACKGROUND

Multimedia players implemented by either hardware or software are very popular, such as, DVD player, VCD player, MP4 player, MP3 player and etc. of hardware type players, and Windows Media Player, Quick Time player and etc. of software type players.

The multimedia player provides normal playback operations, such as operations of play (or called playback), trick mode operations, such as fast forward, reverse, fast reverse, etc and other control operations, such as stop, pause and etc. The operations capable of being provided by multimedia players vary from one player to another, and under some circumstances, additional operation(s) can be added based on developer's specific purpose, e.g. a record operation.

The fast forward operation among trick mode operations is speedup of normal playback, and it is used by a user to search for a specific scene either he is interested in or has missed before. The speed of fast forward operation typically includes 1.5× (1.5 times as speed as normal playback), 2×, 4× etc. and the set of the fast forward speed may vary from one multimedia player to another. Sometimes, the speed of normal playback operation can be denoted as 1×. The reverse operation is reverse of normal playback, and the fast reverse is a fast reverse of normal playback with the speed larger than 1×.

During any trick mode operation, the player will set the volume mute with the video frame played back in a way that is not possible for user to understand what happens during the trick mode operation.

Therefore, a method for content presentation during trick mode operations is desired.

### SUMMARY

According to an aspect of present invention, it is provided a method for content presentation during trick mode operations, wherein a main content file is associated with a plurality of additional content files, and each additional content file corresponds to a content segment of the main content file, the method comprises, during a chosen trick mode operation of a content segment of the main content file, playing back at least one additional content file, which is selected among the plurality of additional content files, corresponding to the content segment for chosen trick mode operation.

According to the aspect of present invention, it facilitates a user to understand what the current video is about during a trick mode operation by playing back the corresponding additional content file(s).

It is to be understood that more aspects and advantages of the invention will be found in the following detailed description of the present invention.

### BRIEF DESCRIPTION OF THE DRAWINGS

The accompanying drawings, which are included to provide a further understanding of the, illustrate embodiments of the invention together with the description which serves to explain the principle of the invention. Therefore, the invention is not limited to the embodiments. In the drawings:

FIG. 1 is an exemplary diagram illustrating an example on preparation of additional audio files for trick mode operations according to an embodiment of present invention;

FIG. 2 is an exemplary diagram illustrating another example on preparation of additional audio files for trick mode operations according to the embodiment of present invention;

FIG. 3 is a flow chart illustrating a method for playing back additional audio files during trick mode operations according to the embodiment of present invention;

FIG. 4 is a diagram illustrating the conceptually partition of the main video file with a time length of 50 minutes according to the embodiment of present invention;

FIG. 5 is a message sequence chart illustrating the playback of auxiliary content for a trick mode operation between a player and a server according to an embodiment of present invention;

FIG. 6 shows an example of a modified program map table according to the embodiment of present invention;

FIG. 7 shows an example of definition of the Trick_mode_descriptor according to the embodiment of present invention;

FIG. 8 shows an example of definition of the Auxiliary_content_type according to the embodiment of present invention;

FIG. 9 shows an example of relationship between main content, auxiliary audio content and auxiliary video content according to the embodiment of present invention;

FIG. 10 shows another example of definition of the Trick_mode_descriptor according to the embodiment of present invention.

### DETAILED DESCRIPTION

An embodiment of the present invention will now be described in detail in conjunction with the drawings. In the following description, some detailed descriptions of known functions and configurations may be omitted for clarity and conciseness.

The present invention proposes to provide a user with a good understanding about what is the video segment of main content (e.g. a movie), which is played back during trick mode operations, about by using additional content. The additional content may be made up of a plurality of content items, which are independent from each other in terms of storage. Each content item corresponds to a video segment and introduces the summary of the corresponding video segment. The correspondence between content items and video segments can be implemented in many ways. One example is that the correspondence is recorded in a table where a starting time and an ending time of a video segment correspond to a content item, or a starting time and the time length of a video segment correspond to a content item. In addition, the additional content can be in one presentation form or combined two or more presentation forms selected from a group including audio, video, text, flash, picture etc.

Embodiments below use additional audio content as the additional content (or called auxiliary content) to explain a method for audio content presentation during trick mode operations. Before the description of the method, description on preparation of additional audio content for all or a subset of trick mode operations is given.

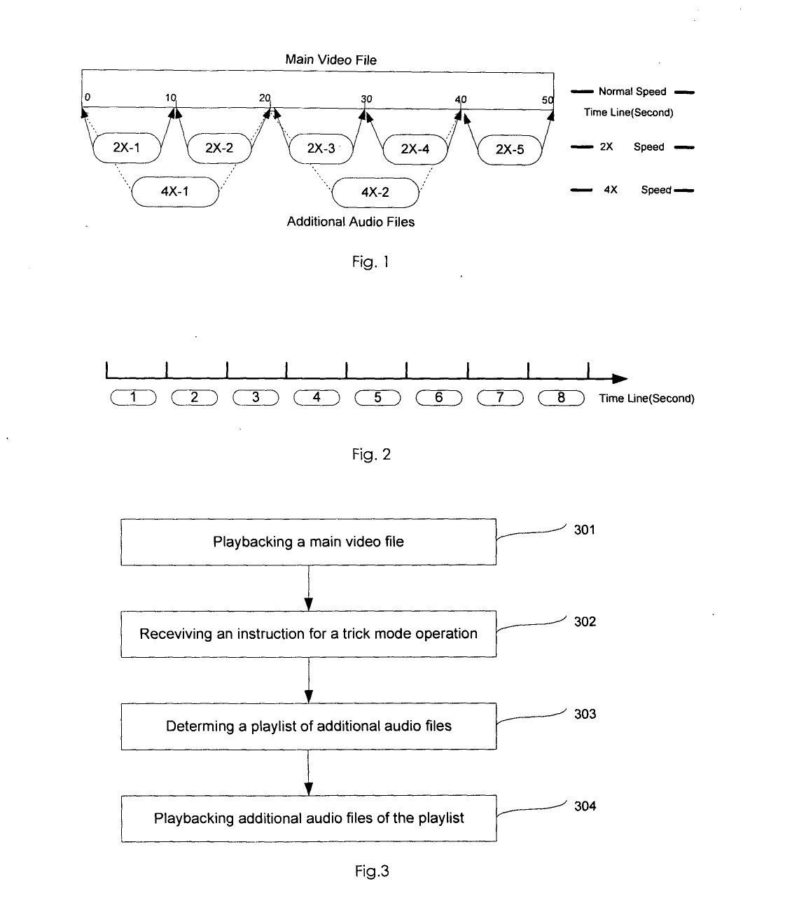

FIG. 1 is an exemplary diagram illustrating an example on preparation of additional audio files for trick mode operations according to an embodiment of present invention. It shall note that the FIG. 1 only shows a portion of a main video file and the corresponding additional audio files, and this example only includes trick mode operations of fast forward 2× speed and fast forward 4× speed. But a person skilled in the art shall appreciate that the principle of present invention shall not limited to 2× speed and 4× speed, and not limited to fast forward trick mode operation. As can be seen from the FIG. 1, this example shows a portion of the main video file of 50 seconds in the time line. In the 2× speed trick mode, the portion is averagely partitioned into 5 video segments of each lasting 10 seconds (the partition here is a conceptual partition, and it does not mean that the video maker needs to process the main video file, e.g. using a video editing software to partition the main video file into a plurality of sub video files); each video segment corresponds to an additional audio file, i.e. addition audio files labeled 2X-1, 2X-2, 2X-3, 2X-4 and 2X-5. The additional audio files are prepared in advance and are used to introduce the summary of their corresponding video segments, e.g. the 2X-3 additional audio file is used to introduce the summary of the video segment starting from the 20^{th} second and ending at 30^{th} second. In the 4× speed trick mode, only 2 additional audio files are shown in this example, i.e. 4X-1 and 4X-2 additional audio files for video segment ranging from 0 second to the 20^{th} second and video segment ranging from the 20^{th} second to the 40^{th} second, respectively. According to a variant, the main video file is not partitioned averagely as the FIG. 1 shows. Instead, it is partitioned in accordance with its scenes. In film industry, a scene is defined as a complete unit of film narration, and in a scene, a series of shots (or a single shot) takes place in a single location and deals with a single action. And consequently, it becomes easier for the video maker (or film maker) to prepare additional audio files for describing scenes of the main video file.

FIG. 2 is an exemplary diagram illustrating another example on preparation of additional audio files for trick mode operations according to the embodiment of present invention. In this example, the video maker does not need to prepare a set of additional content for each trick mode operation, and only one set of additional content is prepared. The main video file is partitioned into video segments, and it can be either average partition or non-average partition. The video maker prepares an additional audio file for each video segment. In addition, the video maker also needs to prepare a formula or a database to indicate which additional audio files will be played back for a trick mode operation. That is, with regard to a selected trick mode operation, a playlist of additional audio files can be generated based on the formula or the database. For example, for the 2× fast forward, the playback sequence of the additional audio files is 1-2-3-4 . . . ; for the 3× fast forward, the playback sequence is 1-3-5-7 . . . ; for the 4× fast forward, the playback sequence is 1-4-7 . . . . It shall note it is easy for a person skilled in the art to prepare a formula or a database to indicate above playback sequences for different trick mode operations, and it shall also note a video maker may use playback sequences different from ones given in above example based on his needs. An advantage the above example brings is the video maker does not need to prepare additional audio files for each trick mode operation as the example in the FIG. 1 does. He only needs to prepare addition audio files for all video segments of the main video file and a formula or a database indicating the playback sequences for all trick mode operations (or a subset of trick mode operations on which the film maker want to apply the principle of the present invention).

As introduced above, the example in the FIG. 1 prepares a set of additional audio files for each trick mode operation while the example in the FIG. 2 only prepares one set of additional audio files for all trick mode operations. It shall note a person skilled in the art may adopt a mixture of the two examples, i.e. the example in the FIG. 1 is adopted for some portions of the main video file and the rest adopts the example in the FIG. 2. In addition, a person skilled in the art shall appreciate that it is possible that some portions of the main video do not adopt example of either FIG. 1 or FIG. 2, i.e. no additional content is prepared for these portions; and in the trick mode operations, the player works in the same way as current player does.

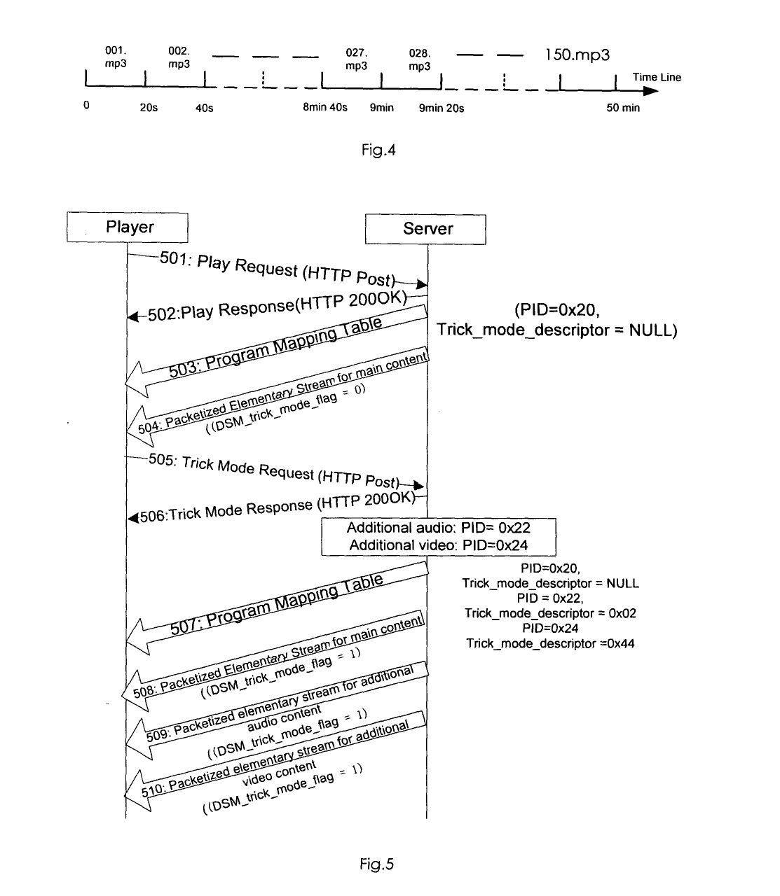

FIG. 3 is a flow chart illustrating a method for playing back additional audio files during trick mode operations according to the embodiment of present invention. In this example, the relationship between the main video file and the additional audio files uses the same way as example of FIG. 2 shows. The additional audio files labeled 0001.mp3, 0002.mp3, 0003.mp3 are stored in the same storage medium as the main video file, for example, in a same folder of a hard disc. However, a person skilled in the art shall appreciate that the additional audio files and the main video file can be burned into a DVD disc for a DVD player. FIG. 4 is a diagram illustrating the conceptually partition of the main video file with a time length of 50 minutes (e.g. a movie file). As can be seen from the FIG. 4, the main video file is averagely partitioned to video segments with each video segment lasting 20 seconds. The correspondence relationship in this example is defined by a formula, i.e. using the integer fraction of the time value dividing 20 seconds to add 1.

In the step 301, a multimedia player plays back the main video file;

In the step 302, the multimedia player receives an instruction for a trick mode operation. For example, at the time of 8 min 45 s, the user uses a remote controller to send a 2× fast forward instruction message, e.g. carried in an infrared signal, to the multimedia player. A person skilled in art shall know that the instruction can be sent by other means via either wired medium or wireless medium.

In the step 303, the multimedia player determines a playlist of additional audio files for the trick mode operation. In this example, the video maker prepares a database for generating playlist of additional audio files. The inputs include current playback time stamp of the main video file when a trick mode operation is triggered, trick mode operation type and its speed. Below shows a table for fast forward operation with 2× speed. With reference to this table, a person skilled in art shall know how to prepare tables in the database for, e.g. 3× fast forward operation, 4× fast forward operation etc. As above example shows, a 2× fast forward operation is triggered at 8 min 45 s. So the generated playlist includes 027.mp3, 028.mp3, 029.mp3, 030.mp3 . . . and 150.mp3. In addition, the principle of this invention can also apply for reverse operation. Considering a 2× fast reverse operation corresponds to a 2× speed reverse table with the same data values as the table 1. When a 2× fast reverse operation is triggered at 8 min 45 s, the generated playlist may includes the play sequence of 027.mp3, 026.mp3, 025.mp3 . . . and 001.mp3. A person skilled in the art shall know that other organizations of tables in the database are also possible, and the main purpose of the database is to generate a playlist of additional audio files based on time information of the main video file and the information about the triggered trick mode operation.

TABLE 1
look up table for 2X speed fast forward

| 2X Speed fast | | |
|---|---|---|
| forward | Starting time | Ending time |
| 001.mp3 | 0 | 20 s |
| 002.mp3 | 20 s | 40 s |
| . . . | . . . | . . . |
| . . . | . . . | . . . |
| 027.mp3 | 8 min 40 s | 9 min |
| 028.mp3 | 9 min | 9 min 20 s |
| . . . | . . . | . . . |
| . . . | . . . | . . . |
| 150.mp3 | 49 min 40 s | 50 min |

In the step 304, the multimedia player plays back the determined playlist of additional audio files. One embodiment is to mute the audio track playback of the main video file and start to play back the additional audio files according to the playlist. For other type of additional content such as video, text, picture, a picture in picture pattern can be implemented in the player. The main content will be displayed as background window, while the additional content will be displayed in the foreground window.

When an instruction of returning to normal playback mode is sent, the multimedia player stops playing back the additional audio files and starts to play back the main video file.

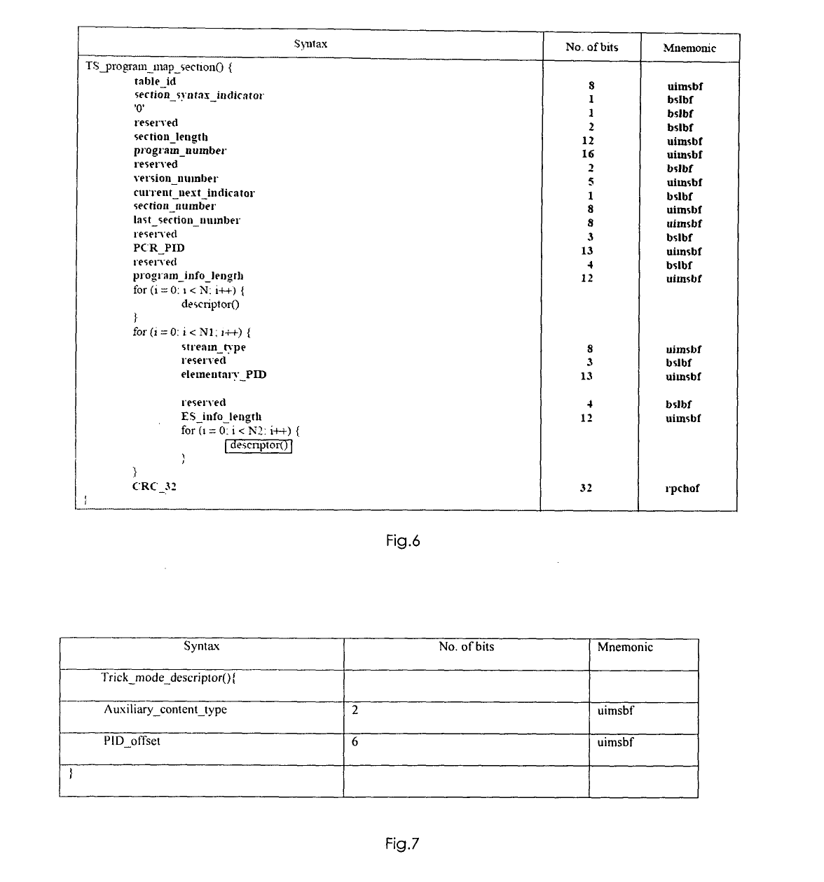

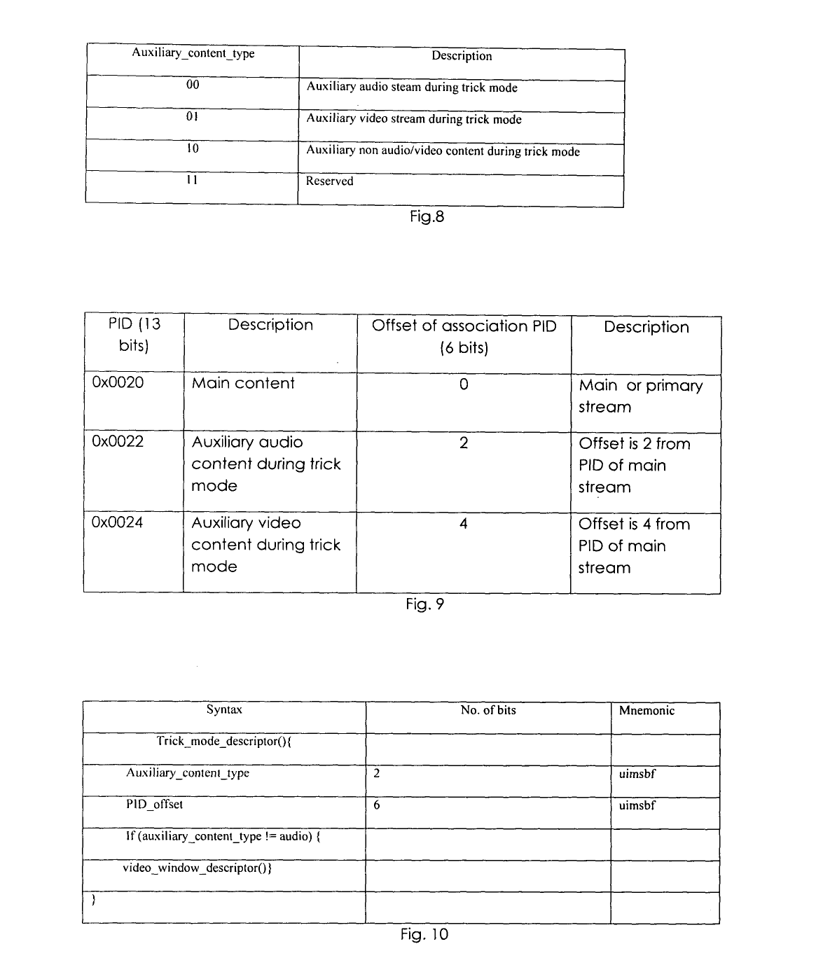

FIG. 5 is a message sequence chart illustrating the playback of auxiliary (additional) content for a trick mode operation between a player and a server according to another embodiment of present invention. The example is set into a system adopting MPEG TS standard (ISO-IEC 13818-1 Information technology—Generic coding of moving pictures and associated audio information: Systems) with modification made to the standard as indicated below. Current MPEG TS format only defines the trick mode operation in the PES packet when the DSM_trick_mode_flag is set to ‘1’. A modification of the MPEG-TS standard is made so as to make it support the principle of the present invention. FIG. 6 is a modified program map table, which is the complete collection of all programs definitions for a transport stream (TS). The program map table shall be transmitted in packets, the program identification (PID) values of which are selected by the encoder. Since the auxiliary content is only triggered to play back during trick mode operations, it does not need to transmit the auxiliary content during normal playback mode, and when the trick mode is triggered, it adds the description of data stream carrying the auxiliary content in the PMT. The detailed description can be found below. As can be seen from the FIG. 6, a descriptor named Trick_mode_descriptor is added to establish the association between the main content and the auxiliary content. FIG. 7 shows the definition of the Trick_mode_descriptor. It contains two fields of Auxiliary_content_type and PID_offset that are used to determine the type of the auxiliary content and PID of datastream carrying the auxiliary content, respectively. FIG. 8 shows the definition of the Auxiliary_content_type, and it shall note that a person skilled in the art can make a definition based on his needs. The PID_offset defines a value offset between a PID value of data stream carrying the main content (which is carried in elementary_PID of FIG. 6) and a PID value of data stream carrying the auxiliary content. For example, assuming the PID of the main content carried in the elementary_PID is 0x0020, and both a auxiliary video content and an auxiliary audio content are associated with the main content during a trick mode operation. When a trick mode operation is triggered, as shown by FIG. 9, the PIDs of auxiliary audio content and auxiliary video content can be obtained by using the PID of main content data stream and offset values. As can be seen from the FIG. 5, a user wants to play back on-line video on demand (VOD).

In the step 501, the player sends a HTTP play post message requesting a video file to the server, with the action description in the message body, one example is “event=play”;

In the step 502, the server gives HTTP play response message with the Status-Code in the header setting as 200, the meaning is “The action was successfully received, understood, and accepted”, the message body of the 200OK response can be null or include the corresponding description of the media content;

In the step 503, the server transmits program map table, and the program map table contains PID of a data stream carrying the requested video file (e.g. PID=0×20) and stream type of video, but the trick_mode_descriptor will be null;

In the step 504, the data of the requested video file is encapsulated in the PES (packetized elementary stream), and then sent to the player through TCP or UDP connection, and the DSM_trick_mode_flag is 0 in the PES header.

In the step 505, when a trick mode operation is triggered in the player, the player sends a new HTTP post message to the server with the action description in the message body, for example, the action description is “event=fast forward”;

In the step 506, the server gives HTTP response with the Status-Code in the header setting as 200, the meaning is “The action was successfully received, understood, and accepted”. And at the server's side, if the auxiliary content is available, the additional content will be assigned PID (e.g. 0×22 for the additional audio stream, 0×24 for the additional video stream). From above description, it can be seen that both additional audio files and additional video files are used in this embodiment. However, a person skilled in art may choose to use only one of them.

In the step 507, the server sends a new program map table to the player. In the new program map table, the modification is the insertion of the 2 new additional contents with the PID definition and the trick_mode_descriptor description.

In the step 508, the PES transmission for the media requested video file is continued to be transmitted in the data stream with PID=0×20 and with the DSM_trick_mode_flag of 1 in the PES header. The player follows the definition in the ISO 13818 to process this data stream of the requested video file;

In the steps 509 and 510, the data of additional audio files and additional video files is transmitted to the player, and the DSM_trick_mode_flag is 1 in the PES header. Regarding the server's preparing the playlists for both additional audio files and additional video files, the server may adopt a same method as used in the method of FIG. 3. After receiving the data streams of additional audio files and additional video files, the player will determine the displaying pattern for the additional audio files and additional video files. One example is to play the additional video files in the foreground window, play the requested video file in the background window, mute the audio track of the requested video file and play the additional audio files.

According to a variant of present embodiment, FIG. 10 shows another example of definition of Trick_mode_descriptor. Compared with the definition in the FIG. 7, video_window_descriptor is added. And the field of video_window_descriptor exists only when the additional content is not audio files. The video_window_descriptor is used to describe the window characteristics of the associated video elementary stream. For example, it can be used to define the horizontal_offset, vertical_offset, window_priority fields of the corresponding window.

The above example is described in a system adopting the MPEG TS standard. It shall note that the principle of the present invention also apply for other standards with some modification to those standards. For example, it can apply for MP4 standard (ISO/IEC 14496-12 Information technology—Coding of audio-visual objects—Part 12: ISO base media file format) with some adaptive changes made to the standard.

The relationship of the primary stream and the auxiliary content can be defined in the Track Reference Box with the definition of following:

Box Type: ‘tref’

Container: Track Box (‘trak’)

Mandatory: No

Quantity: Zero or one

There is already a field named reference_type in this Track Reference Box, we just extend its definition for the trick mode supporting.

The syntax is as follow:

aligned(8) class TrackReferenceBox extends Box(‘tref’) { }
aligned(8) class TrackReferenceTypeBox (unsigned int(32)
reference_type) extends Box(reference_type) {
unsigned int(32) track_IDs[ ];
}

The semantics is as follow:

In current standard definition, the reference_type shall be set to one of the following values:

1. “hint”: the referenced track(s) contain the original media for this hint track.

2. “cdsc”: this track describes the referenced track. and

3. “hind”: this track depends on the referenced hint track.

The extension of the auxiliary content type is ‘cdsc_trick’, this track describes the referenced track and it should only be used if the trick mode is operated. This extension is working for the simultaneously displaying of the primary content and the auxiliary content.

For the deployment scenario that the auxiliary content will replace the primary content during trick mode, for example, the episode introduction audio track will replace the original audio track which will be played in the faster speed under trick mode. The Track Selection Box can be used for such operation. Firstly, the primary track and the auxiliary content will be assigned to the same alternate group, the definition of alternate_group is in Track Header Box (template int(16) alternate_group), If this field is 0 there is no information on possible relations to other tracks. If this field is not 0, it should be the same for tracks that contain alternate data for one another and different for tracks belonging to different such groups. Only one track within an alternate group should be played or streamed at any one time, and must be distinguishable from other tracks in the group via attributes list (unsigned int(32) attribute_list[ ]).The attributes in this list should be used as descriptions of tracks or differentiation criteria for tracks in the same alternate or switch group such as bit rate, codec, language, packet size etc. We make the extension for the attribute field to identify the trick mode operation as follows:

| Name | Attribute | Description |
|---|---|---|
| Trick mode auxiliary | ‘tria’ | The track is for trick mode auxiliary |
| | | content |
| Trick mode | ‘tric’ | The trick mode operation, fast |
| | | forward, reverse |
| Trick mode speed | ‘tris’ | The trick mode operation speed |

With the extension of MP4 standard as described above, a person skilled in art shall contemplate the application of the principle of the present invention on the MP4 standard with reference to the application of the principle of the present invention on MPEG TS standard.

According to a variant of present embodiment, when the auxiliary content is not audio files, the auxiliary content can be displayed in the pattern of PIP (picture in picture). The display region can be defined in the “width” and “height” field in the Track Header Box. The detailed format of the auxiliary content can be defined in the sample table Sample Description Box. Auxiliary audio tracks may be created by an authoring tool, or may be added to an existing presentation by a hinting tool. Such a tool serves as a ‘bridge’ between the media and the protocol. Therefore, when the server receives the event report of the trick mode including the trick mode type and speed, the correct position of the auxiliary track will be determined and the content will be delivered in a new media box.

According to a variant of present embodiment, it does not always need to determine the playlist of additional audio files before playing back them. It can be done in a real time manner, i.e. only determine which additional audio file is going to be used for current video segment, and the next additional audio file will be determined when it goes to the next video segment. This process is repeated until the player returns to normal playback operation.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations shall fall in the scope of the invention.

1-10. (canceled)

11. A method for content presentation during trick mode operations, wherein a first content file is associated with a plurality of content items, and each content item corresponds to a content segment of the first content file, the method comprises,
receiving an instruction for a chosen trick mode operation when a content segment of the first content file is played; and
performing the chosen trick mode operation on the content segment of the first content file and meanwhile playing at least one content item among the plurality of content items, wherein, the at least one content item corresponds to the content segment of the first content file and the chosen trick mode operation.

12. The method of the claim 11, wherein the type of the content items comprise video, audio, text, picture, and flash.

13. The method of the claim 12, comprising
playing two content item corresponding to the content segment of the first content file and the chosen trick mode operation while performing the chosen trick mode operation, wherein, one content item is in the type of audio and the other content item is in the type of video, text, picture or flash.

14. The method of the claim 11, further comprising,
receiving an instruction for the chosen trick mode operation during the playback of the content segment of the first content file at a time point in the timeline of the first content file;
determining a playlist of content items based on the time point and the chosen trick mode operation; and
playing content items in the determined playlist.

15. The method of the claim 11 further comprising,
receiving an instruction for the chosen trick mode operation during the playback of the content segment of the first content file at a time point in the timeline of the first content file;
determining at least one content item based on the time point and the chosen trick mode operation;
playing the determined at least one content item during the trick mode operation of the content segment of the first content file;
repeating determining and playing a next content item based on the time information of the first content file and the chosen trick mode operation as the first content file goes to a next content segment until receiving an instruction for playing the first content file.

16. The method of the claim 11, wherein during the chosen trick mode operation, the first content file is present in a background window, and visual content item within the at least one content item is present in a foreground window.

17. The method of claim 11 wherein the trick mode operation comprises fast forward of different speeds.
